(19) United States
(12) Patent Application Publication
(10) Pub. No.: US 2016/0047901 A1
(43) Pub. Date: Feb. 18, 2016

(54) ROBUST LIDAR SENSOR FOR BROAD WEATHER, SHOCK AND VIBRATION CONDITIONS

(71) Applicant: QUANERGY SYSTEMS, INC., SUNNYVALE, CA (US)

(72) Inventors: Angus Pacala, Menlo Park, CA (US); Tianyue Yu, Sunnyvale, CA (US); Louay Eldada, Sunnyvale, CA (US)

(73) Assignee: QUANERGY SYSTEMS, INC., SUNNYVALE, CA (US)

(21) Appl. No.: 14/140,522

(22) Filed: Dec. 25, 2013

Related U.S. Application Data
(60) Provisional application No. 61/745,795, filed on Dec. 25, 2012.

(51) Int. Cl. G01S 7/481; G01S 17/95

(52) U.S. Cl. CPC G01S 7/4813; G01S 17/95

(57) ABSTRACT

An apparatus and method are used for real-time wide-field-of-view ranging with a time-of-flight lidar sensor having one or a plurality of laser emitters and one or a plurality of photodetectors. When a plurarity of laser emitters are used, they are preferably copackaged or are in the form of an integrated multi-emitter chip or emitting multi-chip module in a single package, and when a plurarity of photoreceivers are used, they are preferably copackaged or are in the form of an integrated multi-photoreceiver chip or photoreceiving multi-chip module in a single package. Furthermore, the apparatus comprises any combination of (a) no moving external parts in contact with the environment, (b) wireless energy and data transfer between the static and the moving parts of the lidar, and (c) protective body, sealant and/or damage-resistant tamper-resistant theft-resistant cage.

### PRIORITY CLAIM

The present Application claims the benefit of priority from U.S. Provisional Application Ser. No. 61/745,795, filed Dec. 25, 2012.

### REFERENCE CITED

U.S. Patent Documents

| | | |
|---|---|---|
| 5,455,669 | October 1995 | Wetteborn |
| 7,746,449 B2 | June 2010 | Ray |
| 7,969,558 B2 | June 2011 | Hall |
| 2011/0216304 A1 | September 2011 | Hall |

### FIELD OF THE INVENTION

The present invention relates generally to the field of vehicle or robot or automated equipment station safety and efficiency, and more particularly to the use of robust time-of-flight lidar sensors for real-time wide-field-of-view detection of objects surrounding a vehicle under a broad range of weather, shock and vibration conditions.

### BACKGROUND OF THE INVENTION

A lidar sensor is a light detection and ranging sensor. It is an optical remote sensing module that can measure the distance to a target or objects in a landscape, by irradiating the target or landscape with light, using pulses from a laser, and measuring the time it takes photons to travel to said target or landscape and return after reflection to a receiver in the lidar module. Lidar sensors based on mechanical spinning achieve a wide field of view. The performance and durability of mechanically spinning lidar sensors are often adversely affected by challenging weather, shock and vibration conditions. Moreover, the lifetime of a lidar sensor can be adversely affected by mechanical impact of solid objects (e.g., hail, rocks) and the sensor module can be the target of vandalism, tampering and theft.

U.S. Pat. No. 5,455,669 discloses a laser range finding apparatus comprising a mirror mounted for rotation along a vertical axis parallel to the vertical axis of light from a pulsed laser being emitted for deflection into the measurement region, and angularly inclined with respect to the plane of rotation and the vertical axis to cause pulsed light from the laser to be diverted over the planar measurement field and reflected light from the measurement region to be received from the planar measurement region and diverted along a vertical path to a photoreceiver arrangement.

U.S. Pat. No. 7,746,449 discloses a light detection and ranging system, comprising a mirror unit rotating around a scan axis, the mirror unit including a receiving portion and a transmitting portion offset by an angle about the scan axis relative to a surface plane of the receiving portion, respective centroids of the receiving and transmitting portions being positioned at a common point on the scan axis.

U.S. Pat. No. 7,969,558 discloses a lidar-based 3-D point cloud system comprising a support structure, a plurality of laser emitters supported by the support structure, a plurality of avalanche photodiode detectors supported by the support structure, and a rotary component configured to rotate the plurality of laser emitters and the plurality of avalanche photodiode detectors at a speed of at least 200 RPM (rotations per minute).

US application 2011/0216304 discloses a LiDAR-based sensor system comprising a base, head assembly, a rotary component configured to rotate the head assembly with respect to the base, the rotation of the head assembly defining an axis of rotation; an electrical motherboard carried in the head assembly, the motherboard defining a plane and being positioned substantially parallel to the axis of rotation, a plurality of photon transmitters mounted to a plurality of emitter circuit boards, the plurality of emitter circuit boards being mounted directly to the motherboard, and a plurality of detectors mounted to a plurality of detector circuit boards, the plurality of detector circuit boards being mounted directly to the motherboard.

### SUMMARY OF THE INVENTION

An apparatus and method are used for real-time wide-field-of-view ranging with a time-of-flight lidar sensor having one or a plurality of lasers and one or a plurality of photodetectors. When a plurarity of lasers are used, they are preferably copackaged or are in the form of an integrated multi-laser chip or emitting multi-chip module in a single package, and when a plurarity of photodetectors are used, they are preferably copackaged or are in the form of an integrated multi-photodetector chip or photodetection multi-chip module in a single package. Furthermore, the apparatus comprises any combination of (a) no moving external parts in contact with the environment, (b) wireless energy and data transfer between the static and the moving parts of the lidar, and (c) protective body, sealant and/or damage-resistant tamper-resistant theft-resistant cage.

Photodetector types include avalanche photodiodes (APD) and PIN diodes (PIN diodes are positive-intrinsic-negative diodes, as they comprise a lightly-doped intrinsic semiconductor region between a p-type or positive-type semiconductor region and an n-type or negative-type semiconductor region).

As opposed to U.S. Pat. No. 5,455,669 and U.S. Pat. No. 7,746,449, the present invention does not necessarily comprise a mirror, and it includes (a) no moving external parts, (b) wireless energy and data transfer between the static and the spinning parts of the lidar and/or (c) a protective body, sealant and/or cage. As opposed to U.S. Pat. No. 7,969,558, the present invention does not require a support structure, can have a single laser emitter and/or a single photodetector, can have copackaged laser emitters and/or photodetectors, can have integrated multi-laser chip or emitting multi-chip module in a single package and/or integrated multi-photodetector chip or photodetection multi-chip module in a single package, and in all cases includes (a) no moving external parts, (b) wireless energy and data transfer between the static and the spinning parts of the lidar and/or (c) a protective body, sealant and/or cage. Further, the photodetectors can be PIN diodes, not only APDs. In addition, the spinning speed can be lower than 200 RPM.

As opposed to US application 2011/0216304, the head assembly is static as opposed to rotating, and only the internal turret is spinning. The entire external body of the lidar in the present invention is static.

### BRIEF DESCRIPTION OF THE DRAWINGS

The following drawings are illustrative of embodiments of the present invention and are not intended to limit the invention as encompassed by the claims forming part of the application.

The schematic diagram of FIG. 1 provides an external view of the lidar 10 of one embodiment of the lidar of the present invention, depicting the static base 20 and the static head assembly 30 that include a window 40 that is transparent at the laser wavelength.

FIG. 2 provides an external and internal view of one embodiment of the lidar of the present invention, depicting the internal spinning turret 50.

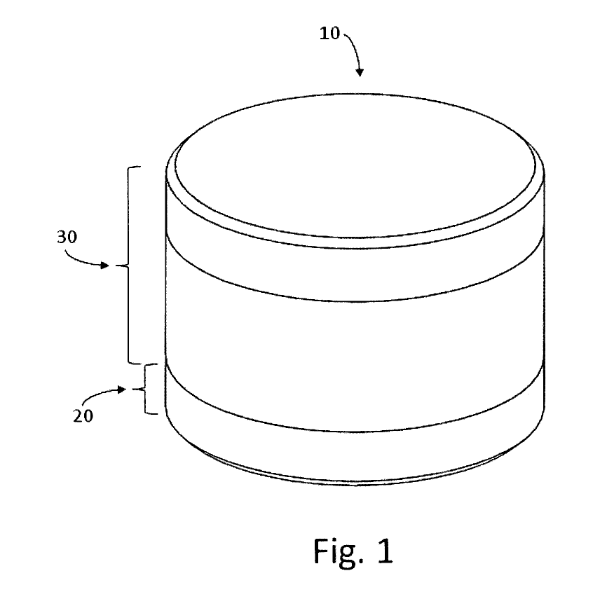

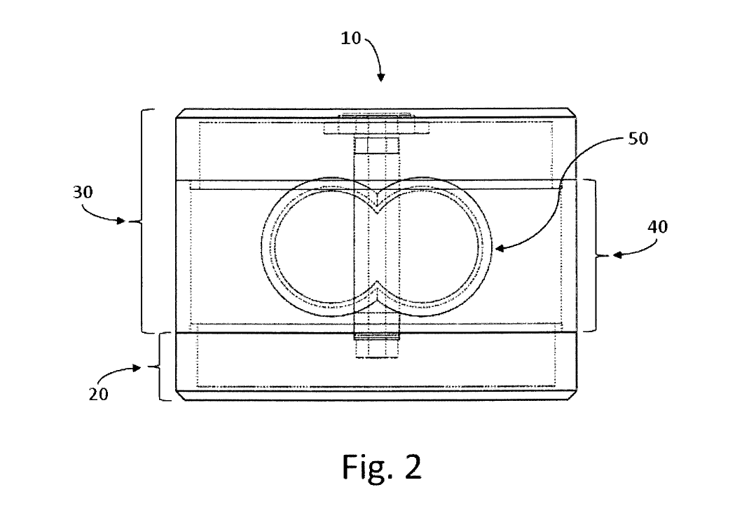

### DETAILED DESCRIPTION OF THE INVENTION

An apparatus and method are used for real-time wide-field-of-view ranging with a time-of-flight lidar sensor having one or a plurality of laser emitters and one or a plurality of photodetectors. When a plurarity of laser emitters are used, they are preferably copackaged or are in the form of an integrated multi-emitter chip in a single package or emitting multi-chip module, and when a plurarity of photodetectors are used, they are preferably copackaged or are in the form of an integrated multi-photodetector chip in a single package or photodetecting multi-chip module. Furthermore, the apparatus comprises any combination of (a) no moving external parts in contact with the environment, (b) wireless energy and data transfer between the static and the moving parts of the lidar, and (c) protective body, sealant and/or damage-resistant tamper-resistant theft-resistant cage. The preferred application is vehicle safety and efficiency.

Some of the advantages of having no moving external parts and an internal spinning turret:

No hazard of having moving parts contact the outside world

No risk of having external elements interfere with the spinning—the lidar could lose its eye-safe rating when not spinning

Ease of achieving a hermetic seal that prevents ingress of moisture and particles

Robustness to staining: any staining (e.g., insect stain) on the transparent window can cause blockage of the laser beam when it is facing the stain, however the lidar maintains a clear view in the remainder of the field of view; however when, as in US application 2011/0216304, the laser emits through the same spot of the transparent window (since the internal assembly is static relative to the window and the entire head assembly spins), a stain on said window can render the lidar blind in the entire 360° horizontal field of view.

What is claimed is:

1. A time-of-flight lidar apparatus for wide-field-of-view ranging, comprising:
a) at least one transmitter-receiver pair;
b) at least one electrically-driven mechanical motion element;
c) a static base;
d) a static external body.

2. The apparatus of claim 1 wherein said electrically-driven mechanical motion element comprises a spinning mirror system.

3. The apparatus of claim 1 comprising a plurality of transmitters.

4. The apparatus of claim 3 wherein said plurality of transmitters include a plurarity of laser emitters that are copackaged.

5. The apparatus of claim 3 wherein said plurality of transmitters include a plurarity of laser emitters in the form of an integrated multi-emitter chip in a single package.

6. The apparatus of claim 3 wherein said plurality of transmitters include a plurarity of laser emitters in the form of an emitting multi-chip module. The apparatus of claim 1 comprising a plurality of receivers.

8. The apparatus of claim 7 wherein said plurality of receivers include a plurarity of photodetectors that are copackaged.

9. The apparatus of claim 7 wherein said plurality of receivers include a plurarity of photodetectors in the form of an integrated multi-photodetectors chip in a single package.

10. The apparatus of claim 7 wherein said plurality of receivers include a plurarity of photodetectors in the form of a photodetecting multi-chip module.

11. The apparatus of claim 1 wherein said electrically-driven mechanical motion element comprises a rotating platform to which at least one of the said transmitter-receiver pairs is rigidly mounted.

12. The apparatus of claim 1 wherein said field of view is 360 degrees.

13. The apparatus of claim 1 wherein each transmitter-receiver pair comprises an avalanche photodiode detector.

14. The apparatus of claim 1 wherein each transmitter-receiver pair comprises a positive-intrinsic-negative diode detector.

15. The apparatus of claim 1 wherein the energy used in each said electrically-driven mechanical motion element is delivered wirelessly from said static base.

16. The apparatus of claim 15 wherein said static base comprises at least one sender induction coil and said mechanical motion element comprises at least one receiver induction coil, thereby forming an electrical transformer, allowing the wireless energy transfer from said base to said element to be achieved inductively by electrical current-magnetic wave-electrical current conversion.

17. The apparatus of claim 1 wherein the data collected by each said transmitter-receiver pair is delivered wirelessly to said static base.

18. The apparatus of claim 17 wherein said wireless data transmission utilizes optical fibers.

19. The apparatus of claim 1 comprising an impact-resistant protective body.

20. The apparatus of claim 1 comprising a sealant that provides protection against particle intrusion and water ingress.

21. The apparatus of claim 20 wherein said sealant provide a hermetic seal.

22. The apparatus of claim 21 wherein said hermetic seal is a glass-to-metal seal.

23. The apparatus of claim 1 comprising a damage-resistant tamper-resistant theft-resistant cage.

24. A method for wide-field-of-view ranging utilizing a time-of-flight lidar apparatus comprising:
a) at least one transmitter-receiver pair;
b) at least one electrically-driven mechanical motion element;
c) a static base;
d) a static external body.

25. The method of claim 24 wherein the energy used in each said electrically-driven mechanical motion element of said apparatus is delivered wirelessly from said static base.

26. The method of claim 24 wherein the data collected by each said transmitter-receiver pair of said apparatus is delivered wirelessly to said static base.

27. The method of claim 24 wherein said apparatus comprises an impact-resistant protective body.

28. The method of claim 24 wherein said apparatus comprises a sealant that provides protection against particle intrusion and water ingress.

29. The method of claim 24 wherein said apparatus comprises a damage-resistant tamper-resistant theft-resistant cage.
